(19) United States
(12) Patent Application Publication
(10) Pub. No.: US 2008/0250179 A1
(43) Pub. Date: Oct. 9, 2008

(54) Discrete Computer Processor System and Peripherals System

(76) Inventor: Sung Ub Moon, Richmond (CA)

Correspondence Address: KLARQUIST SPARKMAN, LLP, 121 SW SALMON STREET, SUITE 1600, PORTLAND, OR, 97204, US

(21) Appl. No.: 12/088,645

(22) PCT Filed: Sep. 28, 2006
(86) PCT No.: PCT/CA2006/001618

§ 371 Date: Mar. 28, 2008

Related U.S. Application Data
(60) Provisional application No. 60/721,537, filed on Sep. 29, 2005.

(51) Int. Cl. G06F 13/00

(52) U.S. Cl. 710/300

(57) ABSTRACT

A discrete, self-contained computer processing system includes a housing, a motherboard carried by the housing, a central processing unit operatively connected to the motherboard, a volatile memory operatively connected to the motherboard, and one or more connectors operatively connected to the motherboard to selectively operatively connect a peripheral device to the motherboard to operate with the device. No other computer-operated components and no computer-operated peripheral devices, are carried by the housing. A discrete peripherals unit operatively connectable to the processing system includes one or more computer-operated peripheral devices and does not include a motherboard, a central processing unit and volatile memory.

### FIELD OF THE INVENTION

This invention relates to improvements to a computer hardware system and more particularly relates to a discrete self-contained computer processing system in which a minimal number of components utilized by a computer processor are housed within a discrete housing, separate from other components of a computer system and separate from computer-operated peripheral devices. A complementary discrete self-contained computer peripherals unit is connectable to the computer processing system and includes computer operated peripheral devices and other components of a computer system.

### BACKGROUND

Improvements to hardware technologies in the fields of Personal Computers, Computer Servers, Pocket PCs and PDA's are advancing at a rapid pace both in terms of speed of operation and functionality of these devices, as well as continual reductions in cost. The major components of a computer hardware system are a monitor (or display), a case (or housing), a power supply, a motherboard with a computer processing unit (CPU or “processor”), volatile and non-volatile memory, optical drives, and various input/output devices. One significant aspect of these advancements is the improvements that are constantly being made to the processor (CPU). Often the type of processor and its processing power are the aspect of a computer most relevant to purchasers and users of a computer system as those aspects are fundamentally determinative of the processing power and other attributes of the computer including its price. These key aspects are of fundamental importance to a computer user's purchasing choice. While advances are also being made to other components of a computer, such as memory, hard disk drives, optical drives and other components, those advances are not as critical nor do they proceed with the same speed as processor advances. In fact the technologies and protocols of these components can change very little over time, as compared to processor improvements. As well those components, even if not the most up-to-date type, often remain compatible for use with a more advanced processor.

Replacing an existing processor with a newer processor having improved performance is by far the most critical aspect in order to keep up with computer hardware advances.

However often when a new improved processor is introduced into the market it cannot be readily installed, or installed at all, in a computer due to incompatibility between the new processor and the motherboard of the computer. This leaves the user with little choice but to purchase an entire replacement computer system in order to upgrade to the new processor. The prior computer becomes obsolete in favour of the new even though many of the components of the prior computer are perfectly acceptable for continued use.

This adds considerably to the expense of upgrading and is wasteful.

As a consequence there is a need for a discrete computer processor unit (sometimes called a discrete self contained computer processing system) which contains a processor and minimal other components and which is housed separately from other components of a computer. That discrete unit could be connected to another discrete unit containing various computer peripherals (sometimes called the peripherals device system) by means of a USB cable connecting USB ports on each unit. This would permit upgrading of a computer system to an improved processor by only replacing the unit containing the processor and minimal other components, that is replacing only the Discrete Computer Processor Unit. The Peripherals Unit can continue to be used by attaching it to a newer Discrete Computer Processor Unit containing an upgraded processor. Furthermore the Discrete Computer Processor Unit can be attached through the USB port of a computer to utilize the components in that computer.

The Discrete Computer Processor Unit of the present invention could also be configured for internal placement within the computer, including placement in an empty optical drive or HDD bay of that computer. In the situation of internal placement the unit would normally be uncovered except for a face plate. The user can either connect the components in the computer directly to the related connectors of the Discrete Computer Processor Unit configured for internal placement, such as IDE, SATA or other standard peripheral connectors. Alternatively the user may connect the components in the computer to such a unit through a USB port.

Advantageously such a separate Discrete Computer Processor Unit could be configured to act as a small stand-alone personal computer as it has connectors for Micro HDD and SODIMM for basic computing function.

A system incorporating a Discrete Computer Processor Unit also has significant manufacturing advantages. In particular logistics and inventorying of parts becomes much simpler. The various peripheral computer components (such as peripheral storage, FDD, Card reader, 2^{nd} and additional Hard Disk Drives, optical drives, and other input/output devices) do not need to be bundled in a single unit coupled to the motherboard and exiting CPU. Instead the manufacturer can inventory a smaller amount of parts for the Discrete Computer Processor Units. Newer upgraded Discrete Computer Processor Units containing the latest CPU's could be coupled with existing peripherals computer components to provide a constant upgrade of computer systems. Those peripheral computer components in computers or in the Peripheral units would be attachable to the Discrete Computer Processor Unit through a USB or other port on the Discrete Computer Processor Unit. Also the shipping costs of the system could be reduced as the size of the Discrete Computer Processor Unit is much smaller than a regular Personal Computer which has its storage devices and other peripheral computer components.

### ADVANTAGES

By separating the processor and its necessary ancillary components (such as a motherboard,) in the Discrete Computer Processor Unit from the computing system, several advantages can result:
1. Upgrading or modification of the CPU and/or the ancillary components of the Discrete Computer Processor Unit can occur quickly, simply, easier and for minimal cost. Upgrading to a higher speed or better functioning CPU could be undertaken conveniently at low cost.
2. Peripheral components of a computer system (such as internal hard drives and CD or DVD drives) may be readily retained in situations where only the CPU or its ancillary components are upgraded or otherwise changed. The Discrete Computer Processor Unit can be connected to an existing Computer system to provide improved power of the upgraded CPU in that Unit. The new Discrete Computer Processor Unit can thereby use the existing peripheral components in an existing computer system. In this manner users can save the cost of the peripherals while improving the performance of the overall computer system.
3. Peripheral components in computers or in the Peripherals Unit can be upgraded or changed while retaining the existing Discrete Computer Processor Unit with the existing CPU and its ancillary components.
4. Computer manufacturing and assembly procedures can be streamlined with lower logistics and inventory costs and greater flexibility in choices offered to customers.
5. The Discrete Computer Processor Unit can be kept very small in size due the small size of components built into it resulting in enhanced portability to other locations for use with peripheral components (including a Peripherals Unit) at that location. In addition a Discrete Computer Processor Unit can be used in other applications where small size is an advantage, such as industrial machine control systems, car multimedia systems, video players (DVD or music video), home entertainment systems and so on.
6. As the Discrete Computer Processor Unit is very small in size it may be installed inside of a computers or the Peripherals Unit. For example it may be dimensioned to fit within the standard 5.25″ drive bay size (that is the standard size of a regular CD-ROM drive) or 3.5″ drive bay size (the standard size of a regular floppy disk drive). As these drive bays are industry standard in size, and as most of computers and the Peripherals Units have extra empty drive bays, the Discrete Computer Processor Unit could be installed in the standard drive bays to save space for users and provide a “clean” upgrade.
7. A Discrete Computer Processor Unit can be a functional personal computer, which is particularly advantageous where a user does not need computer peripherals at his or her station, such as in an office networked environment.
8. A Discrete Computer Processor Unit can include powerful and reliable server CPUs, so that it can be used in a computer server environment which requires more powerful processors.

### SUMMARY OF THE INVENTION

The present invention provides computer hardware modifications to provide a Discrete Computer Processor Unit physically separated from computer peripherals components but connectable to each other by means of USB ports or other connectors. This improves the mobility of basic computing devices and upgradeability of a typical PC computer system as well as enabling the continued use of other peripheral components such as storage devices in computers. This provides an economical solution for computer users who are looking for long term viability of their existing computer components and flexibility in upgrading certain computer components, such as by separately upgrading the Discrete Computer Processor Unit with an improved CPU. For manufacturers, assemblers and distributors of computers, it can provide improved inventory control, design flexibility, productivity and reduction of transportation and logistic cost.

The invention is comprised of two discrete units, each of which is self contained and physically separated from the other, but which are connectable when in use by means of a USB cable or other standard cables. One is a Discrete Computer Processor Unit containing the processor, motherboard and a few related accessories and the other is the Peripherals Unit containing various computer peripherals such as hard drives, optical drives and various other computer peripherals. Additionally a display device, which could be a standard computer display product, touch screen monitor, or small sized LCD and an input device such as a keyboard or mouse may be connected to the Discrete Computer Processor Unit to configure a complete computing system. The Discrete Computer Processor Unit includes a video out connection to connect to the RGB Video connection of the Display Device.

The Peripherals Unit includes several drive bays into which a user or manufacturer could install optical drives (CD-ROM, DVD-ROM and so on) or storage drives (Hard Disk Drives and the like), a Floppy Disk Drive, a Card reader, a USB HUB, and Internal Speakers and so on.

In one aspect of the invention the Discrete Computer Processor Unit includes a CPU, a small form factor memory (such as on board or small outline dual In-line memory module(s) (SODIMM)) and a small form factor hard disk drive (such as micro HDD) with video out and USB connection. For this aspect, all connection to other devices would be through the USB port except the video connection and power connection. The CPU could be the same type of processors of typical personal computer systems or notebook personal computers and could also comprise a CPU used with a computer server system. The Discrete Computer Processor Unit could be used independently as a small form factor personal computer like a thin client PC, a pocket PC, PDA, music/video player and the like.

In another aspect of the invention the Discrete Computer Processor Unit includes a CPU, a small form factor memory (such as on board or small outline dual In-line memory module(s) (SODIMM)) and a small form factor hard disk drive (such as micro HDD) with video out and USB connection, but also includes standard IDE, SATA connectors on the board. In this form, this Discrete Computer Processor unit could be packaged in the standard 5.25″ drive bay size (normally size of regular CD-ROM) or 3.5″ drive bay size (normally size of regular Floppy Disk Drive). As these drive bays are industry standard, and most of computers and the Peripheral units has extra empty drive bays, the Discrete Computer Processor Unit could be installed in one of those standard drive bays. The peripheral components (Hard Disk Drives, Optical drives) of the computer or Peripherals Unit could be connected directly to the connectors of the Discrete Computer Processor Unit.

The Discrete Computer Processor Unit could also be used in a server product (a high performance system). Server products which require high performance sometimes include dual processors or high speed processors. When a server system needs to be upgraded to improve performance, a Discrete Computer Processor Unit containing an upgraded processor or multiple processors could be connected to the existing servers or other data systems. The server could use the higher performance processor power from the Discrete Computer Processor Unit without replacing the entire server system. If users set up an appropriate load-balance function, several Discrete Computer Processor Units could function together for even better performance with existing servers.

The Peripherals Unit contains computer peripherals and acts as a storage device. It can include several drive bays to permit installation of optical drives, hard disk drives, card readers, floppy drives, a USB hub, internal speakers and so on. The Peripherals Unit could be linked to a personal computer or notebook PC without utilizing the Discrete Computer Processor Unit, if desired. The Peripherals Unit could include a USB HUB, 10/100 Network HUB, and/or Wireless Network router to give users more connectivity to other devices. When the Discrete Computer Processor Unit is connected to the Peripherals Unit, extended full computer functionality can be available to users. The Peripherals Unit provide users with storage devices for long-term use. Thus in the event that an improved processor is introduced into the market, the user can still use the Peripherals Unit storage devices and other components, or those of another computer system, connect with a Discrete Computer Processor Unit containing the improved processor. The User can thereby retain his or her existing storage devices, data, and other components and thereby save considerable time and money in upgrading in this manner.

As well, the Discrete Computer Processor Unit is small enough to be easily transported from one location to another. This enables the Discrete Computer Processor Unit to be carried to a location where an existing unitary computer system of typical design is located to use peripheral devices installed in that computer, such as a hard disk drive, optical drives, card readers, floppy disk drives, etc.

Key objects in designing the Discrete Computer Processor Unit are both mobility and the ability to keep up with processor improvements without losing any data contained in peripheral components thereby reducing upgrade and migration costs and time. There are several small PCs currently on the market, like PDA's, Pocket PC's or Handheld PC's. However, they use a mostly embedded processor which suffer from reduced processor performance as compared to regular computers. Notebook PC's are manufactured smaller than regular PC's, but are not yet as small as a PDA or similar computing device as they include full functional storage devices, optical devices and display devices. There are a few smaller size personal computers smaller than regular computers, but as they also include full functional storages and optical devices, they have the same disadvantages as other regular computers in terms of the upgradeability of processors. All smaller computers in the market have the upgradeability problem discussed as they retain fully functional peripheral components inside of these devices.

Applicant's Discrete Computer Processor Unit includes a regular computer's processor but in a unit that could be the size of Pocket PC while retaining all basic functionality and performance of a regular PC or a computer server. The Discrete Computer Processor Unit could easily function as a small size Personal Computer enabling users to more readily incorporate up-to-date processor power and performance as improvements occur.

After a user purchases a Discrete Computer Processor Unit, and later when a new higher performance processor enters the market, the user can upgrade his computer system by purchasing a replacement Discrete Computer Processor Unit containing the new processor thereby replace the existing processor. At the user's option the existing Small form factor Memory (SODIMM) and Small form Factor Hard Disk Drive (Micro HDD) from the user's previous Discrete Computer Processor Unit could be transferred to the new Discrete Computer Processor Unit. That new Discrete Computer Processor Unit could be connected to the user's existing Peripherals Unit as before. Thus the user can take the benefit of the upgraded processor, by paying only for the Discrete Computer Processor Unit, while retaining all of the associated devices in the Discrete Computer Processor Unit and the Peripherals Unit.

By separating out the components in the Discrete Computer Processor Unit from the components in the Peripherals Unit users can purchase a Peripherals Unit configured only with internal storage devices (such as a hard disk drive, optical drives, card readers, and/or floppy disk drives, etc.) without any CPU and its related components. Users could each have their own Discrete Computer Processor Unit and share a Peripherals Unit in order to access the peripherals installed on the Peripherals Unit. Substantial cost savings to users could result.

Additionally the Discrete Computer Processor Unit could be directly connected to additional components through its USB port or video port (or could be internally configured with additional components) to provide additional functionality for use separate from the Peripherals Unit. For example a Touch Screen LCD could be connected to the Discrete Computer Processor Unit to enable its use as a stand-alone computer system or PDA type PC. The Discrete Computer Processor Unit could be connected to an Input device (such as a Keyboard and/or Mouse) through USB ports. Optional any USB devices (for example, a USB-Blue Tooth converter, USB-Network converter, USB-Wireless Network converter, USB Speaker, and so one) could also be connected to the Discrete Computer Processor Unit.

### DESCRIPTION OF THE DRAWINGS

FIG. 1 is a front perspective view of the Discrete Computer Processor Unit (the discrete self contained computer processing system) of the present invention;

FIG. 2 is a rear perspective view of the Discrete Computer Processor Unit of FIG. 1;

FIG. 3 is a top view of the Discrete Computer Processor Unit of FIG. 1;

FIG. 4 is a front view of the Discrete Computer Processor Unit of FIG. 1;

FIG. 5 is a side view of the Discrete Computer Processor Unit of FIG. 1;

FIG. 6 is a front perspective view of the Peripherals Unit (the peripherals device system, vertical orientation) of the present invention;

FIG. 6-1 is a front perspective view of the Peripherals Unit (the peripherals device system, horizontal orientation) of the present invention;

FIG. 7 is a front perspective view of the Peripherals Unit of FIG. 6 showing internal peripherals;

FIG. 7-1 is a front perspective view of the Peripherals Unit of FIG. 6-1 showing internal peripherals;

FIG. 8 is a front perspective view of the Discrete Computer Processor Unit and Peripherals Unit of FIGS. 1 and 6 respectively, shown together for use in combination;

FIG. 9 is a top view of the Discrete Computer Processor Unit and Peripherals Unit combination of FIG. 8;

FIGS. 10-A through 10-R are block diagrams of exemplary alternate configurations of the Discrete Computer Processor Unit of FIG. 1;

FIGS. 11-A through 11-H are block diagrams of exemplary alternate configurations of the Peripherals Unit of FIG. 6;

FIG. 12 is a perspective view of the Discrete Computer Processor Unit of a second embodiment of the invention which may be installed in a compute or Peripherals Unit drive bay;

FIG. 13 is an exploded view of a Discrete Computer Processor Unit of FIG. 12; and

FIG. 14 is a front perspective view of the Peripherals Unit (the peripherals device system, horizontal orientation) with the Discrete Computer Processor unit inserted into the 5.25″ drive bay of the Peripherals Unit.

### DETAILED DESCRIPTION OF PREFERRED EMBODIMENTS

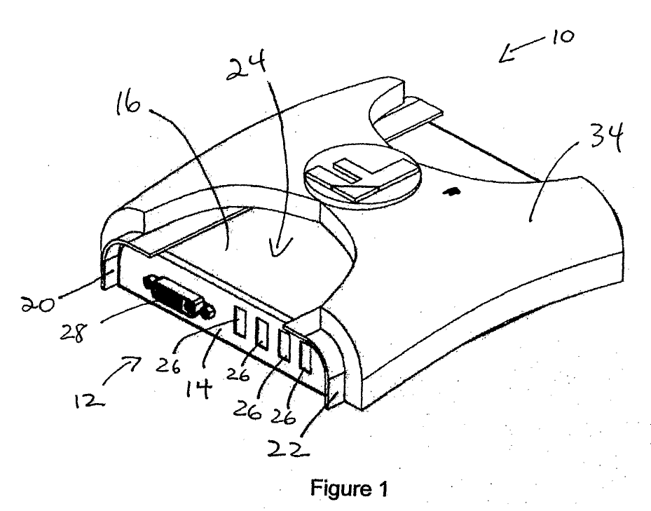

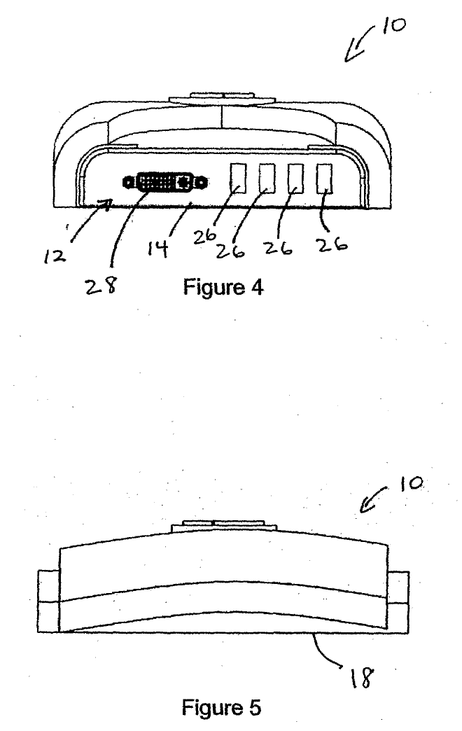

FIGS. 1 through 5 depict front perspective, rear perspective, top, front and side views, respectively, of the discrete computer processor unit 10 of an embodiment of the subject invention.

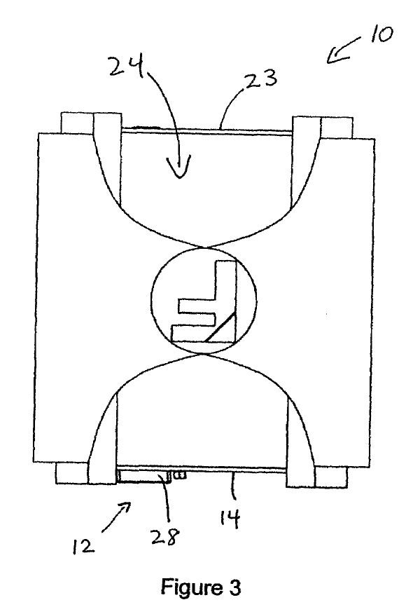

Unit 10 includes face plate 14, top plate 16, lower plate 18 (FIG. 5), left side plate 20, right side plate 22 and rear plate 23 (FIG. 3) which together form housing 24 to completely enclose the inner components of unit 10, other than components which extend through face plate 14 and rear plate 23, as will be described below. Housing 24 is discrete, that is it forms a housing that provides a self-contained computer processing system as regards unit 10, containing a motherboard, computer central processing unit and certain ancillary components. Unit 10 is discrete and self-contained in that it contains only these specific components separated from other components of a typical computer system, including separated from most peripheral computer components.

Housing 24 need not be completely enclosed and associated components, that is a motherboard, computer central processing unit and certain ancillary components, may be carried by housing 24 without being enclosed within the housing 24.

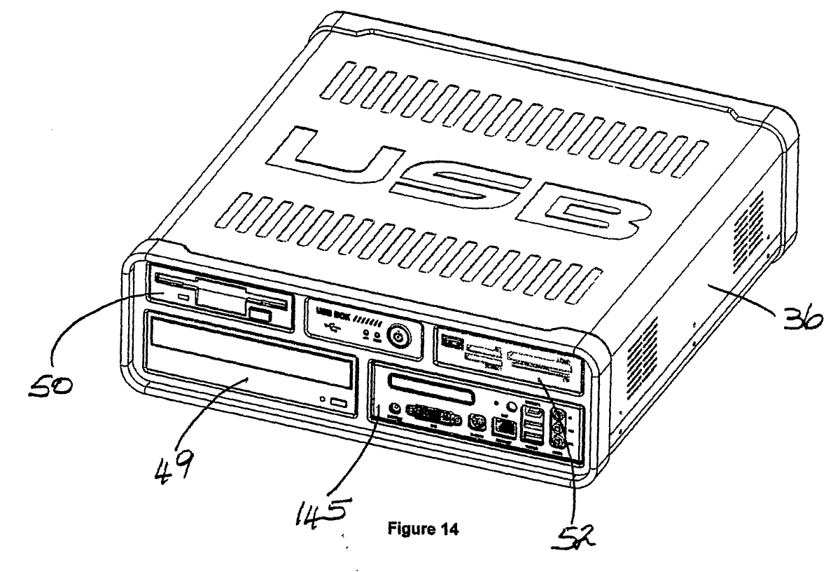

For example, unit 10 may contain an appropriate computer processor together with a small form factor motherboard to fit within unit 10. Appropriate small form factor (SODIMM) random access memory (RAM) can be connected to the motherboard within the housing 24. A display interface may be provided to connect a display device. One or more USB interfaces can be provided to connect USB 2.0 and/or USB 1.1 cables to unit 10. The USB cables may be attached to various peripherals, to work with unit 10. In the event that unit 10 is configured to fit inside the Peripherals Unit (FIG. 14) or a computer system, an SATA or IDE interface may be provided in order to connect hard disk drives, optical drives and the like to unit 10 as desired by a user.

In addition to the above described unit 10, configured at a more basic level, unit 10 may also include various optional additional components, including an audio interface. Unit 10 may also optionally include a battery, either a standard battery or a rechargeable battery. If rechargeable, a battery charging circuit would be included. Unit 10 may further include as an optional component wireless LAN, Bluetooth and/or IrDA connection for infrared data exchange between unit 10 and a typical standard computer or a Peripherals Unit as more fully described below. In addition, unit 10 can optionally include various sockets for inserting memory cards such as an SD card, CompactFlash card or PCMCIA cards and the like, for reading and writing to those cards with unit 10. Unit 10 may also include a USB host-to-host bridge for direct connection with storage devices such as a CD-ROM drive, Hard Disk Drive, Floppy Disk Drive in the computer or in the Peripheral Units.

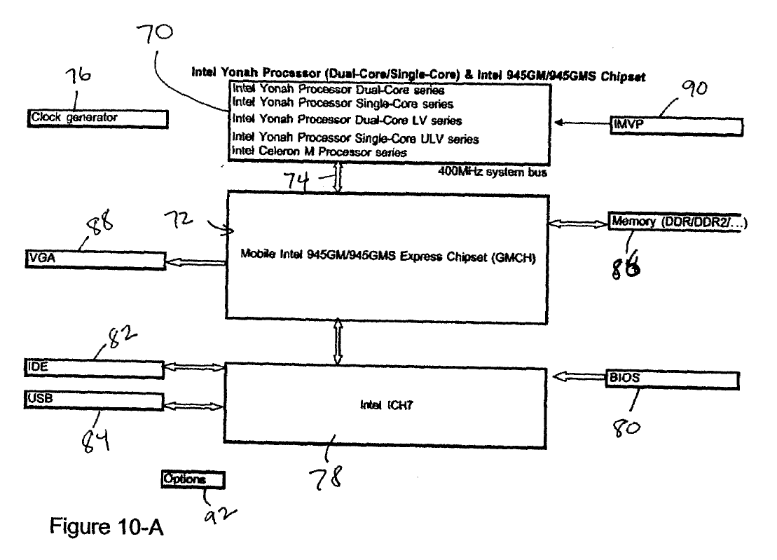

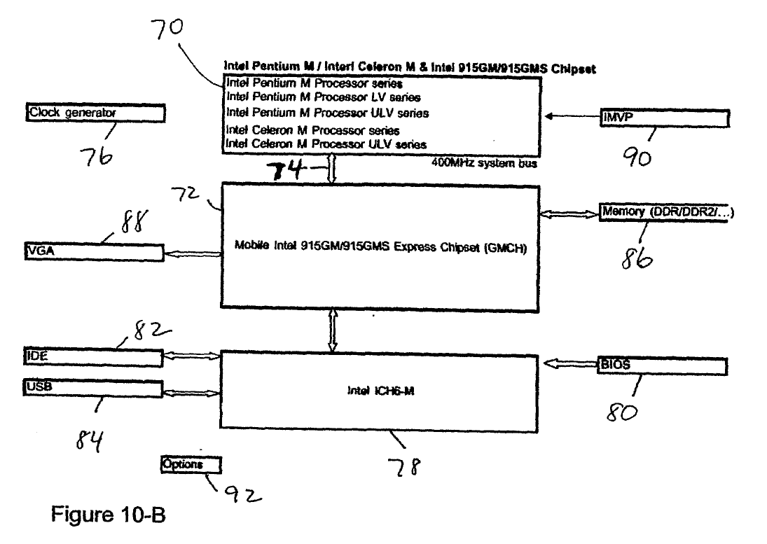

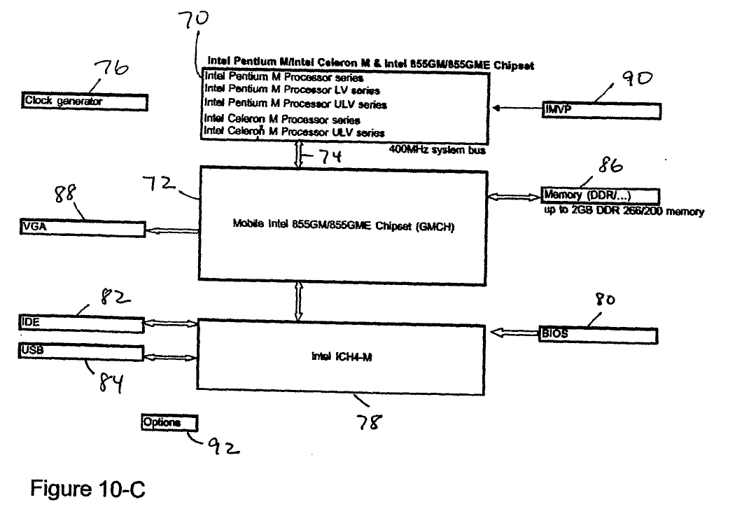

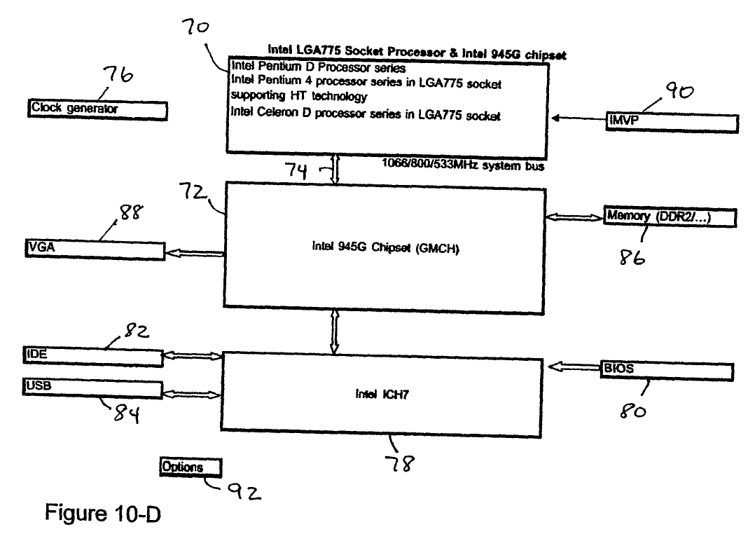

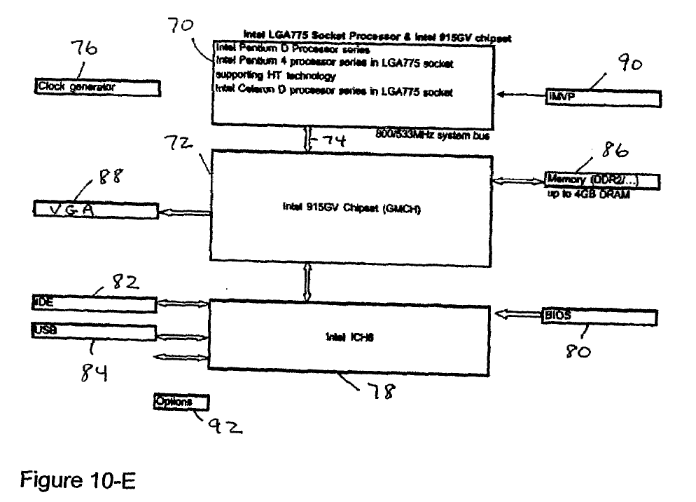

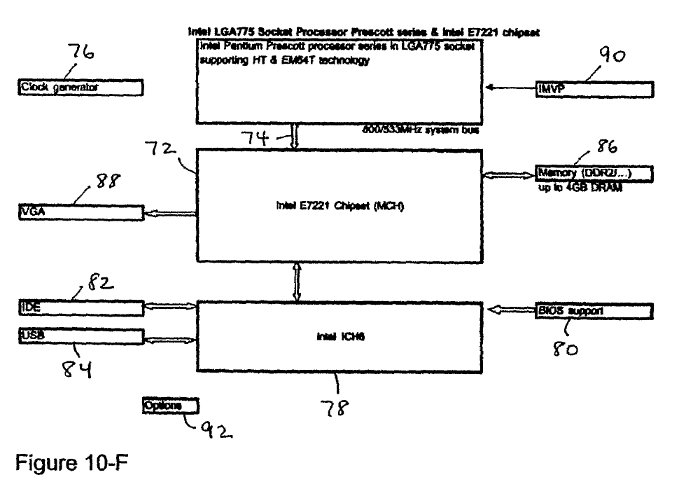

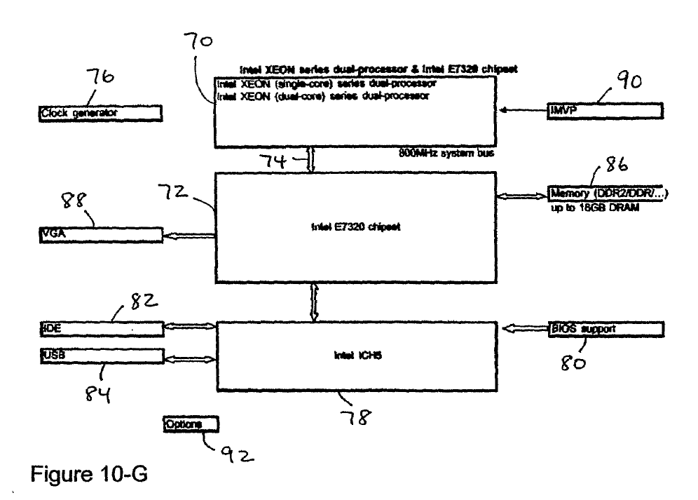

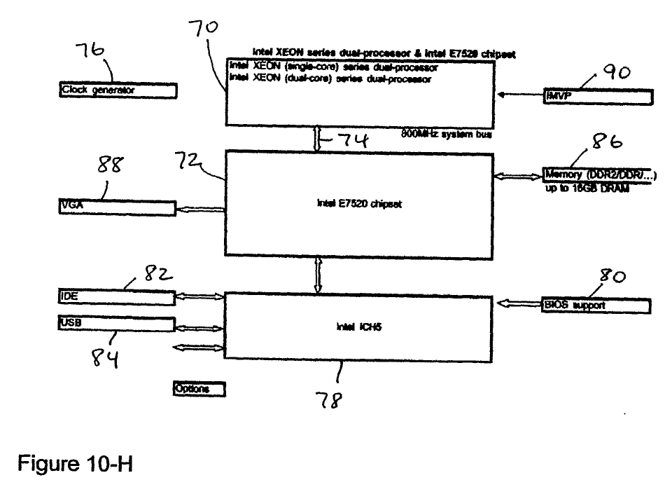

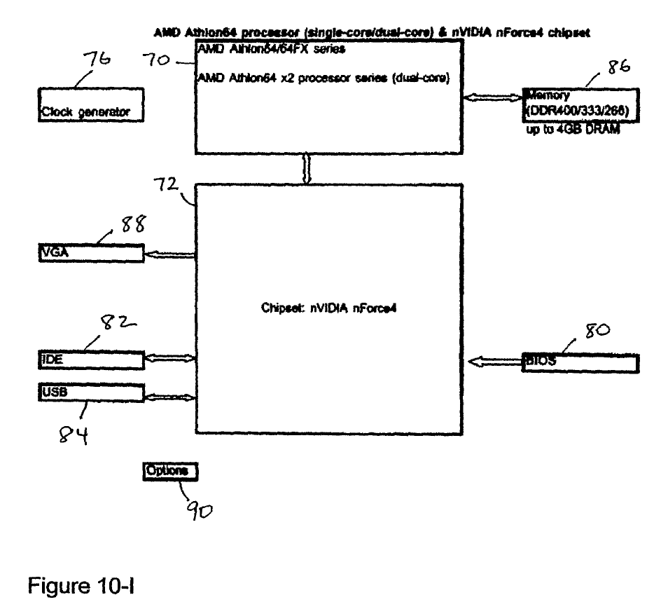

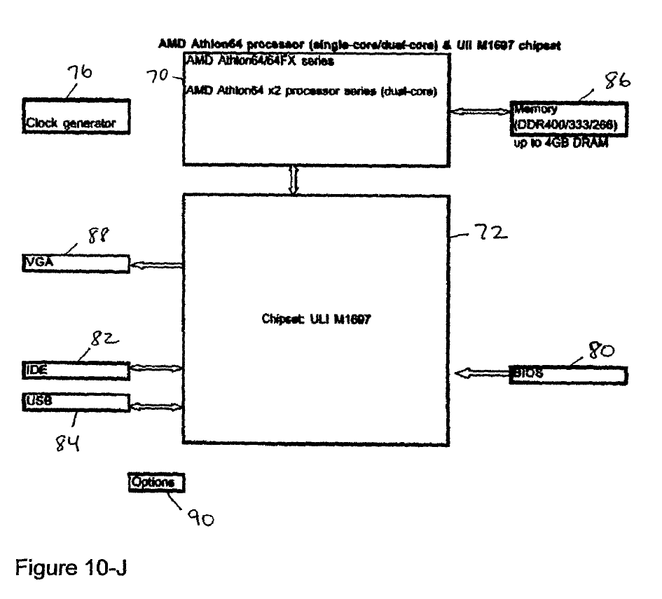

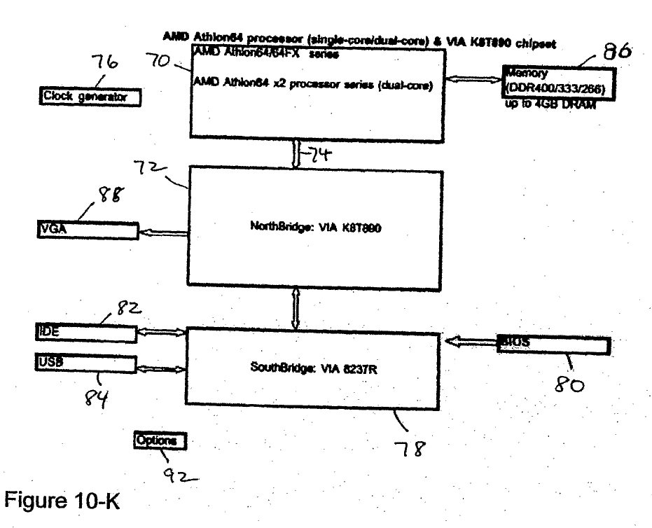

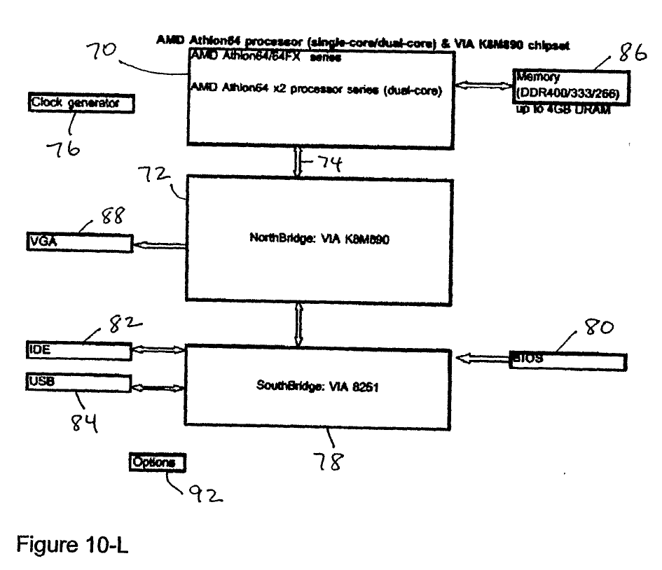

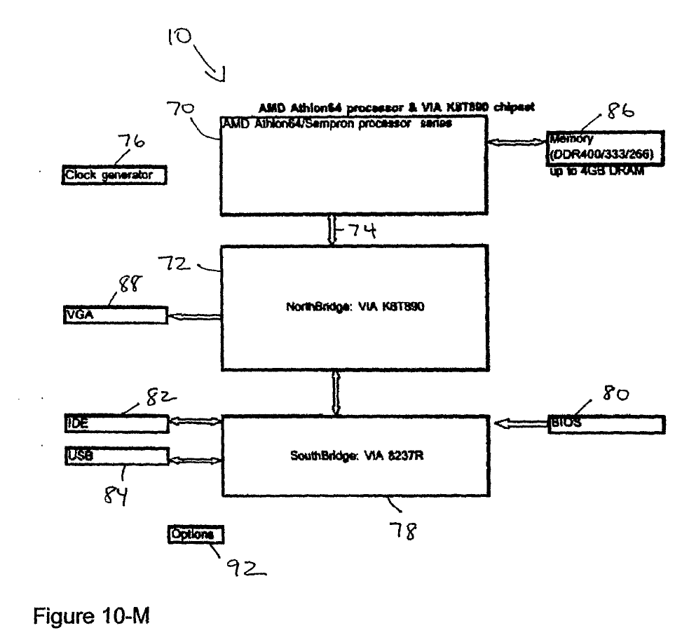

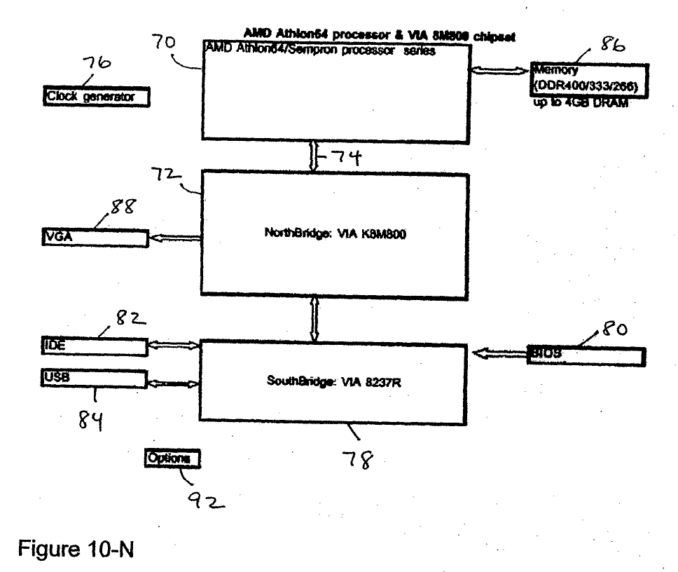

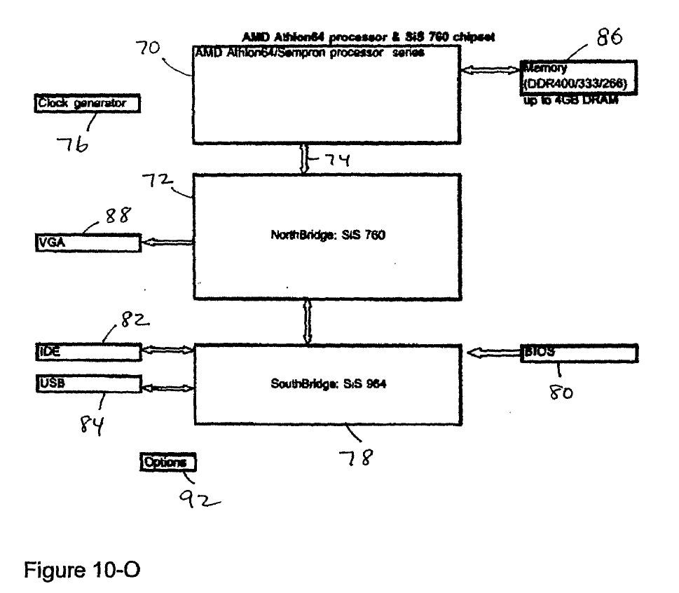

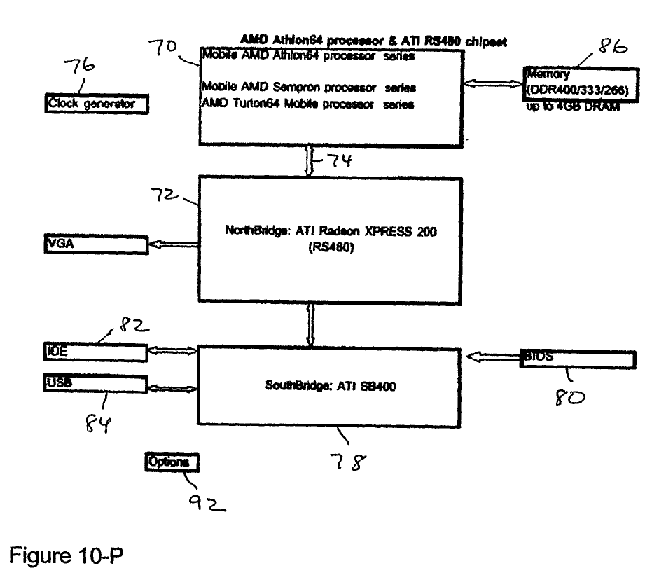

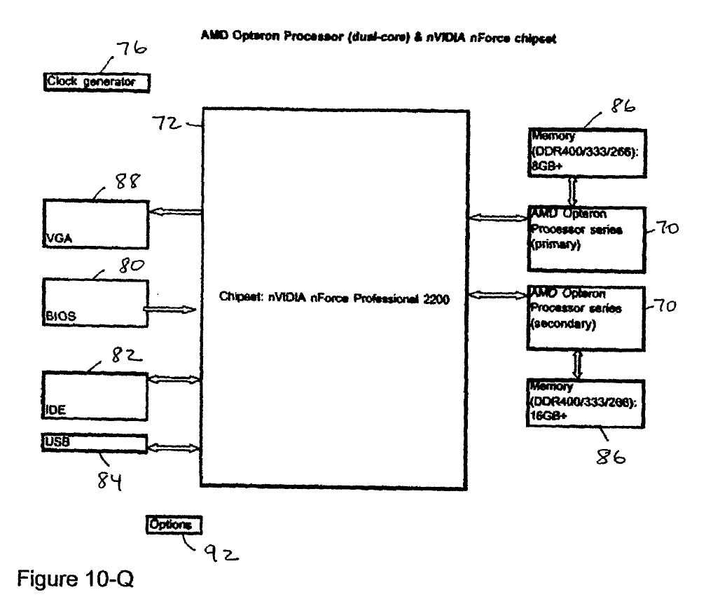

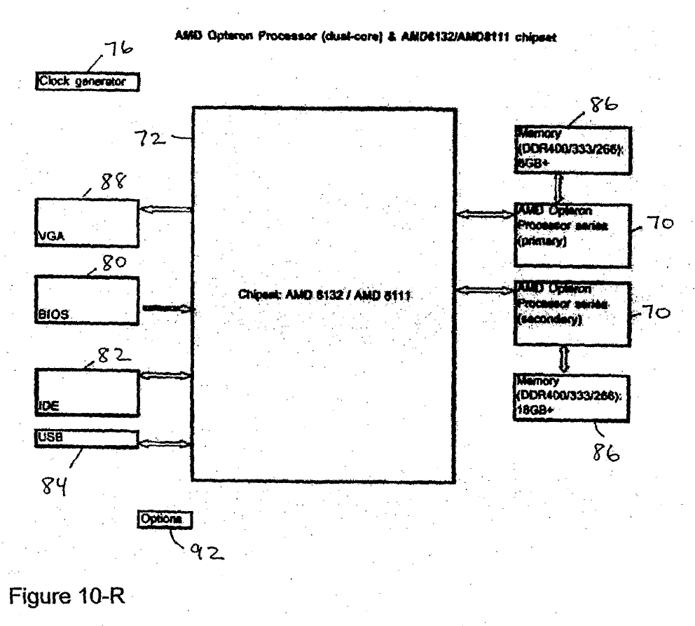

The motherboard of the Discrete Computer Processor Unit has similar components as compared to a regular PC's motherboard. It would include a North Bridge (or Core chip like Intel® 945GM/945GMS for example) to control memory, processors and optionally video, and a South Bridge (or IO chip like ICH 6-M, ICH 7). Users and manufacturers could choose processors based on the components of the North Bridge. FIGS. 10-A through to 10-R show different types of North Bridge (or Core chips) and their supporting processors. New future North Bridge (or Core chips) designs and corresponding processors would be implemented in the same manner as contained in these exemplary Discrete Computer Processor Units 10.

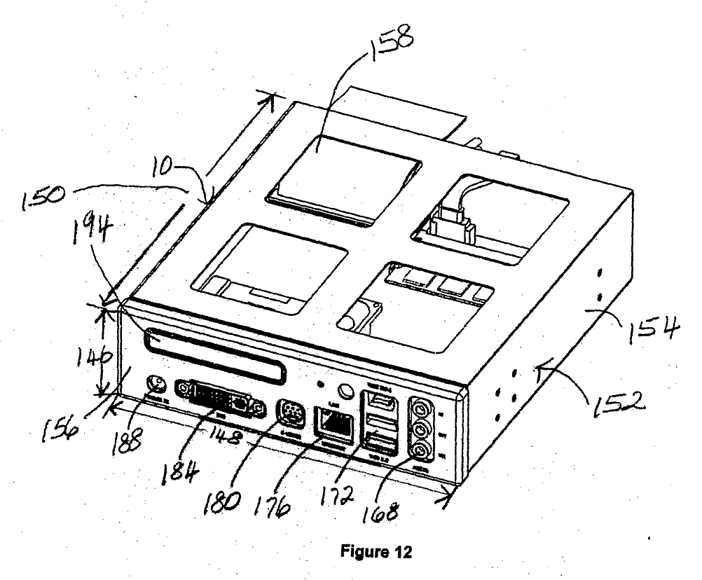

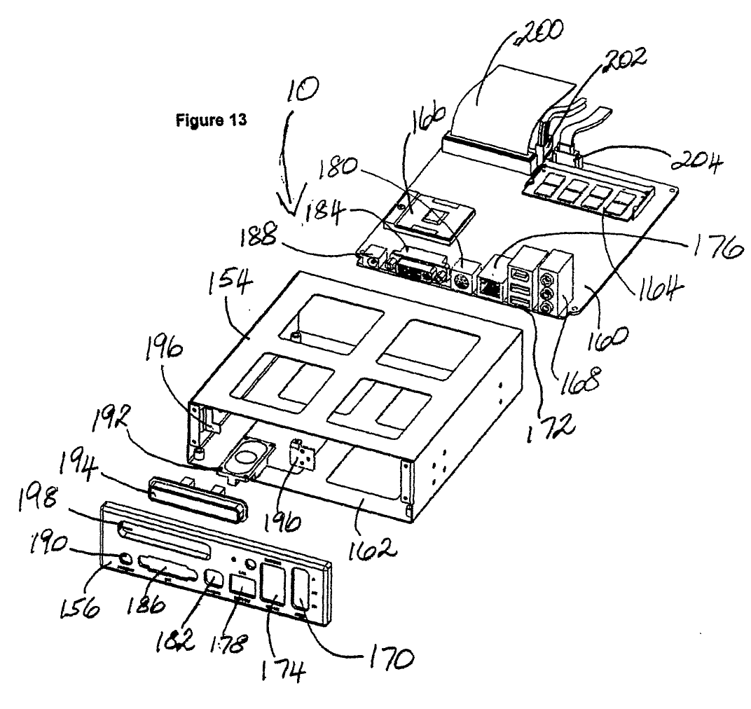

Face plate 14 includes a series of USB ports 26 (Universal Serial Bus ports). Face plate 14 further includes DVI (Digital Visual Interface) port 28. USB ports 26 are connected internally within housing 24 to a printed circuit board sometimes called a motherboard, similar to that shown with respect to an alternate embodiment in FIGS. 12 and 13. USB ports 26 are used to connect various computer peripherals by means of a typical USB cable.

DVI port is likewise connected to the printed circuit board contained within housing 24 and is used to connect unit 10 to a digital monitor such as a flat panel display using an appropriate DVI cable, in a manner readily apparent to one skilled in the art.

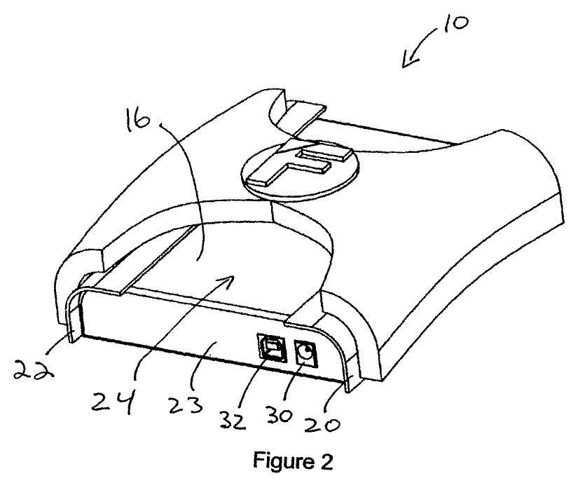

As depicted in FIG. 2, rear plate 23 includes openings, one opening containing power jack 30 for connection to a power source and the other opening containing another USB port 32. Alternatively, the second opening could access a LAN port for connecting to an internet/LAN cable which connects unit 10 to a network such as an intranet or the Internet, in a manner readily apparent to one skilled in the art.

Unit 10 may also optionally contain cover 34 used to protect unit 10 from damage and also provide enhanced appearance to unit 10, particularly useful as unit 10 of the first embodiment is designed as an external device attachable externally to applicant's peripherals unit (discussed below) or to a typical personal computer system. Optionally, the Discrete Computer Processor Unit 10 could include components to provide the functionality of an MP3 player, Music/Movie Player, Voice Recorder and/or USB Memory drive. A standard battery or rechargeable battery may provide power to operate the MP3 player, Music/Movie Player, Voice Recorder and/or USB Memory drive.

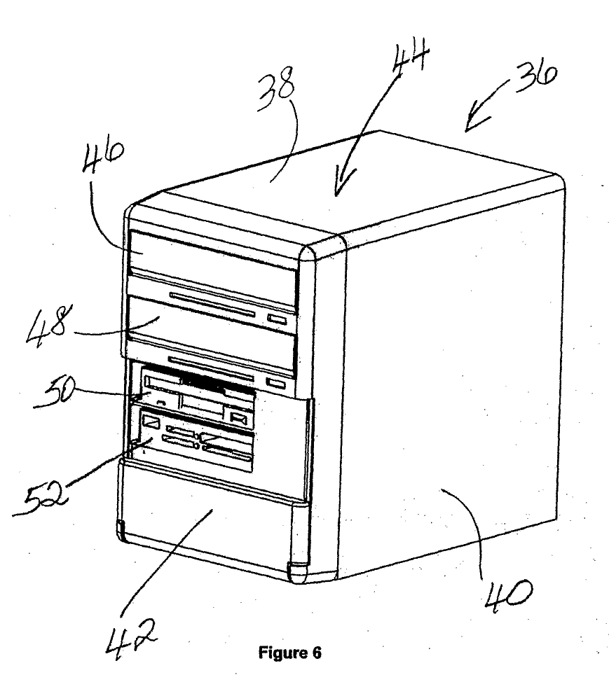

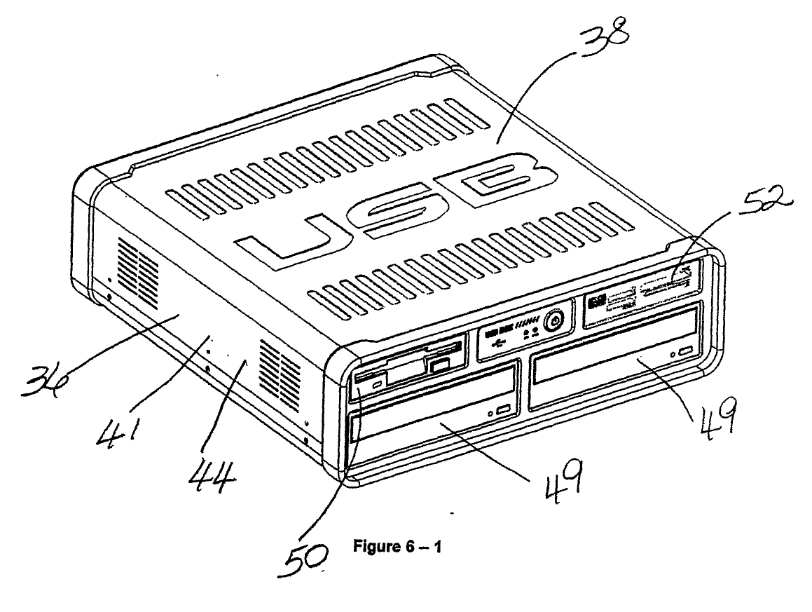

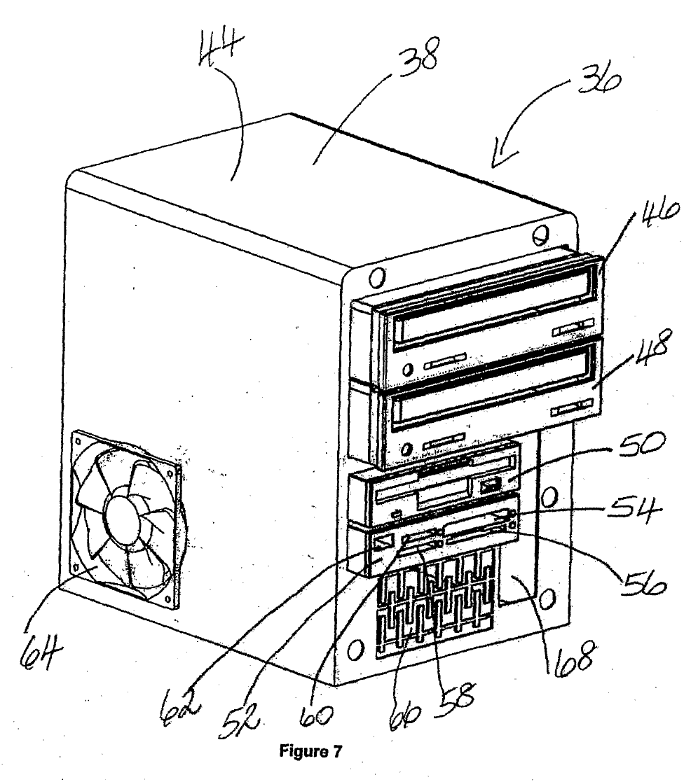

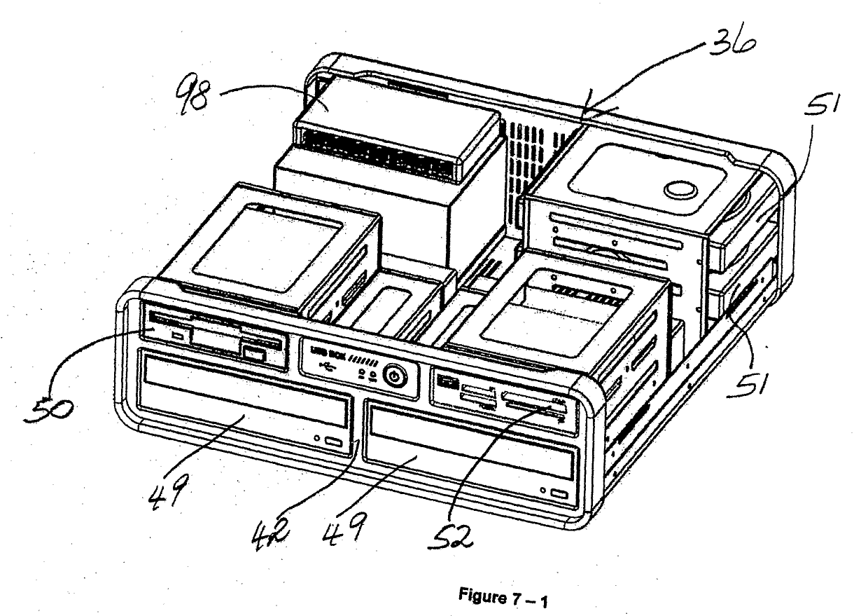

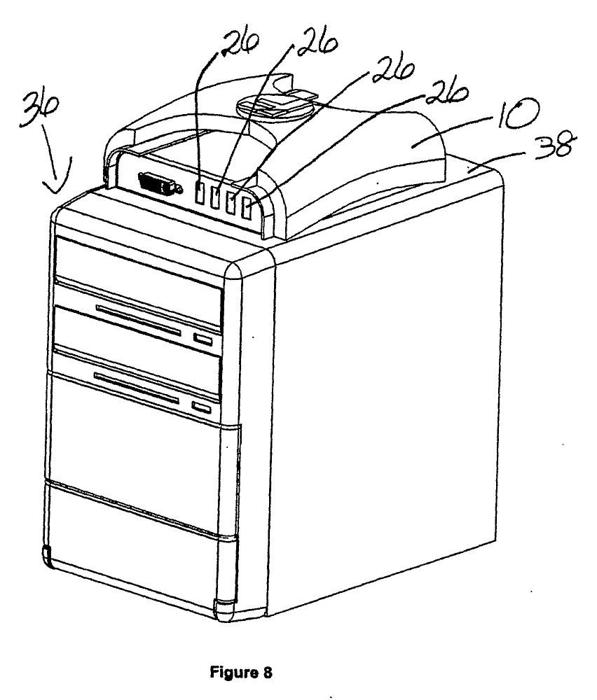

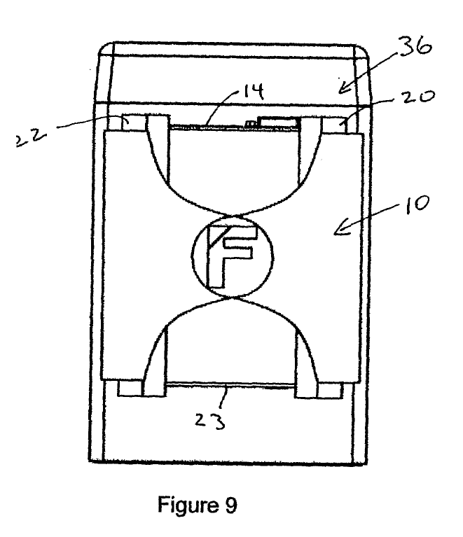

FIGS. 6, 6-1, 7 and 7-1 depict an embodiment of the peripherals unit 36 of the subject invention. FIGS. 6 and 7 depict a vertical orientation and FIGS. 6-1 and 7-1 a horizontal orientation. Peripherals unit 36 is similar to a typical personal computer system, although somewhat smaller in dimensions and containing less internal components, as discussed more fully below. Peripherals unit 36 has several bays to install various computer peripherals. As most storage drives have an IDE interface, peripherals unit 36 could have several IDE to USB converters. Optionally several USB converters for a Floppy drive, Hard Disk Drive, Optical Drives, RS-232C, Ethernet, SATA, etc. may be installed. In this manner a user or manufacturer may install regular storage drives or other components into peripherals unit 36, and the components can be recognized as USB devices when peripherals unit 36 is connected to a computer's USB port or the USB port 26 of the Discrete Computer Processor Unit 10. Peripherals unit 36 has its own power supply and USB converter.

Unit 36 comprises upper side 38, lower side (not shown), left side 41 (FIG. 6-1), right side 40, front 42 and rear (not shown) which form housing 44 of unit 36. Housing 44 is discrete. That is it forms a housing that provides a self-contained peripherals unit 36, containing computer peripherals as desired by a user. Peripherals Unit 36 does not contain a central processing unit (CPU), a motherboard, or volatile memory (DRAM or SRAM for example) as those components are separated and contained in unit 10.

In the example of FIGS. 6, 6-1, 7 and 7-1, Unit 36 includes a pair of hard disk drives 51 (FIG. 7-1), upper optical drive 46 and lower optical drive 48, or in the horizontal orientation of FIGS. 6-1 and 7-1, optical drives 49. Drives 46, 48 and 49 are of typical size and fit within openings in front 42.

Unit 36 further includes floppy drive 50 extending through front 42 for accepting and reading from, and writing to, floppy discs.

Unit 36 further includes card reader 52 which includes various card reader slots 54, 56, 58, 60 and 62 for reading various memory cards, dimensioned and configured to accept and read various types of typical memory cards available in the retail marketplace.

Drives 46, 48 and 50 as well as card reader 52 are connected internally within housing 44 to a USB hub 98 (FIG. 7-1) and only one USB port extends outwardly from unit 36 for connection to unit 10 by means of a USB cable connected to USB port 26 of unit 10 when in use.

Alternatively, Drives 46, 48 and 50 as well as reader 52 may be connected internally within housing 44 to an internal Unit 10 dimensioned to fit within an existing drive bay of unit 36, directly through its appropriate connectors. This is depicted in FIG. 14.

Drives 46, 48, 50 as well as card reader 52 could be substituted with alternate types of drives at the option of the manufacturer or purchaser.

Unit 36 further includes fan system 64 used to cool the various components, including drives 46, 48 and 50 as well as 52, contained within unit 36.

Unit 36 of FIGS. 6 and 7 further includes open space 66 and 68 for inserting and housing various computer peripheral components, as desired by a user, or for inserting unit 10 of an alternate embodiment described with respect to FIGS. 12 and 13. Alternatively, as depicted in FIG. 14 one of the optical drives 49 of FIG. 6-1 may be removed to make room for inserting unit 145, an alternate embodiment of unit 10. Power is supplied to peripherals unit 36 in a typical manner by means of an electrical connection through an electrical cord and electrical plug (not shown).

Referring to FIGS. 8 and 9, Discrete Computer Processor Unit 10 is shown resting on top of upper side 38 of peripherals unit 36. Unit 10 is functionally connected to peripherals unit 36 by means of a USB cable (not shown) connected to a USB port 26 of unit 10 at one end and to a USB port in peripherals unit 36 at the other end. When combined in this manner, unit 10 and peripherals unit 36 operate as a typical personal computer as the internal components of units 10 and 36, in combination, contain all functional components of a typical PC computer. A keyboard or other input device (including a mouse) is connected to unit 10 by means of a USB port 26, and a video display device is connected by means of a DVI cable to unit 10. Each of units 10 and 36 are connected to a power source to power units 10 and 36.

As an alternative to the external unit 10 depicted in FIGS. 8 and 9, unit 10 may be housed internally within unit 36 as shown with respect to a horizontal peripherals unit 36 in FIG. 14. Unit 10 is functionally connected to peripherals unit 36 by means of a USB cable (not shown) or directly to the peripheral components (not shown) When combined in this manner, unit 10 and peripherals unit 36 operate as a typical personal computer as the internal components of units 10 and 36, in combination, contain all functional components of a typical PC computer. A keyboard or other input device (including a mouse) is connected to unit 10 by means of a USB port 26, and a video display device is connected by means of a DVI cable to unit 10. Each of units 10 and 36 are connected to a power source to power units 10 and 36.

Referring to FIG. 10-A which depicts the internal components of unit 10 containing either a duo-core or single-core Intel® Yonah® processor 70 and an Intel® 945GM or 945GMS chip set 72 connected by means of a 400 MHz system bus 74. Five alternative Intel® computer processors may be selected as processor 70 as currently contemplated. In the embodiment of FIG. 10-A these alternatives are:
(a) Intel® Yonah Processor Dual-Core Series;
(b) Intel® Yonah Processor Single-Core Series;
(c) Intel® Yonah Processor Dual-Core LV Series;
(d) Intel® Yonah Processor Single-Core ULV Series; or
(e) Intel® Celeron M Processor Series.

In FIG. 10-A chipset 72 is connected to an Intel® ICH7 on I/O chip 78. Others required parts such as BIOS, Clock generator, Processor (or processor socket), Memory (or memory slot), and other ancillary components and connectors are on I/O chip 78.

Computer BIOS 80 is on I/O chip 78 in a typical fashion. IDE interface 82 for connecting a mass storage device is connected to I/O chip 78. Further, one or more USB ports 84 are connected to I/O chip 78 and extends through openings in unit 10 (FIG. 1).

RAM memory 86 is on I/O chip 78 and VGA interface 88 on I/O chip 78 for connecting an external monitor to unit 10.

IMVP power source controller 90 (Intel Mobile Voltage Positioning) controls power to unit 10 ensuring longer battery life.

Options 92 represents optional components which may be connected to I/O chip 78 within housing 24 of unit 10. Typical and exemplary options 92 for unit 10 are Firewires (1394 connection), Audio functions, Network connections, Wireless Network connections, Blue Tooth connections, new Drive connections and so on.

Referring to FIGS. 10-B to 10-H and 10-K to 10-P, clock generator 76, IDE port 82, USB port 84, memory 86, VGA interface 88, IMVP 90 (Intel Mobile Voltage Positioning) and Options 92, are identical to that described with respect to FIG. 10-A, although various examples of specific types of components are provided in each figure.

As regards processor 70, chipset 72 on I/O chip 78 of FIGS. 10-B to 10-H, the following table sets out the options as depicted in block diagram form in those figures.

| | | Core Chipset | |
|---|---|---|---|
| FIG. | Processor 70 Alternatives | 72 | I/O chip 78 |
| 10-B | Intel ® Pentium M Processor series | Mobile Intel | Intel ICH6-M |
| | Intel ® Pentium M Processor LV series | 915GM/915G | |
| | Intel ® Pentium M Processor ULV series | MS Express | |
| | Intel ® Celeron M Processor series | Chipset | |
| | Intel ® Celeron M Processor ULV series | (GMCH) | |
| 10-C | Intel ® Pentium M Processor series | Mobile Intel | Intel ICH4-M |
| | Intel ® Pentium M Processor LV series | 855GM/855G | |
| | Intel ® Pentium M Processor ULV series | ME Chipset | |
| | Intel ® Celeron M Processor series | (GMCH) | |
| | Intel ® Celeron M. Processor ULV series | | |
| 10-D | Intel ® Pentium D Processor series | Intel 945G | Intel ICH7 |
| | Intel ® Pentium 4 processor series in | Chipset | |
| | LGA775 socket supporting HT technology | (GMCH) | |
| | Intel ® Celeron D processor series in | | |
| | LGA775 socket | | |
| 10-E | Intel ® Pentium D Processor series | Intel 915GV | Intel ICH6 |
| | Intel ® Pentium 4 processor series in | Chipset | |
| | LGA775 socket supporting HT technology | (GMCH) | |
| | Intel ® Celeron D processor series in | | |
| | LGA775 socket | | |
| 10-F | Intel ® Pentium Prescott processor series in | Intel E7221 | Intel ICH6 |
| | LGA775 socket supporting HT & EM64T | Chipset | |
| | technology | (MCH) | |
| 10-G | Intel ® XEON (single-core) series dual- | Intel E7320 | Intel ICH5 |
| | processor | chipset | |
| | Intel ® XEON (dual-core) series dual- | | |
| | processor | | |
| 10-H | Intel ® XEON (single-core) series dual | Intel E7520 | Intel ICH5 |
| | processor | chipset | |
| | Intel ® XEON (dual-core) series dual- | | |
| | processor | | |
| 10-K | AMD ® Athlon64/64FX series | NorthBridge: | SouthBridge: |
| | AMD ® Athlon64 x2 processor series (dual- | VIA K8T890 | VIA 8237R |
| | core) | | |
| 10-L | AMD ® Athlon64/64FX series | NorthBridge: | SouthBridge: |
| | AMD ® Athlon64 x2 processor series (dual- | VIA K8M890 | VIA 8251 |
| | core) | | |
| 10-M | AMD ® Athlon64/Sempron processor series | NorthBridge: | SouthBridge: |
| | | VIA K8T890 | VIA 8237R |
| 10-N | AMD ® Athlon64/Sempron processor series | NorthBridge: | SouthBridge: |
| | | VIA K8M800 | VIA 8237R |
| 10-O | AMD ® Athlon64/Sempron processor series | NorthBridge: | SouthBridge: |
| | | SiS 760 | SiS 964 |
| 10-P | Mobile AMD ® Athlone64 processor series | NorthBridge: | SouthBridge: |
| | Mobile AMD ® Sempron processor series | ATI Radeon | ATI SB400 |
| | AMD ® Turion64 Mobile processor series | XPRESS 200 | |
| | | (RS480) | |

| FIG. | Processor Block 70 Alternatives | Chipset Block 72 |
|---|---|---|
| 10-I | AMD ® Athlon64/64FX series | nVIDIA nForce4 |
| | AMD ® Athlon64 x2 processor series | |
| | (dual-core) | |
| 10-J | AMD ® Athlon64/64FX series | ULI M1697 |
| | AMD ® Athlon64 x2 processor series | |
| | (dual-core) | |

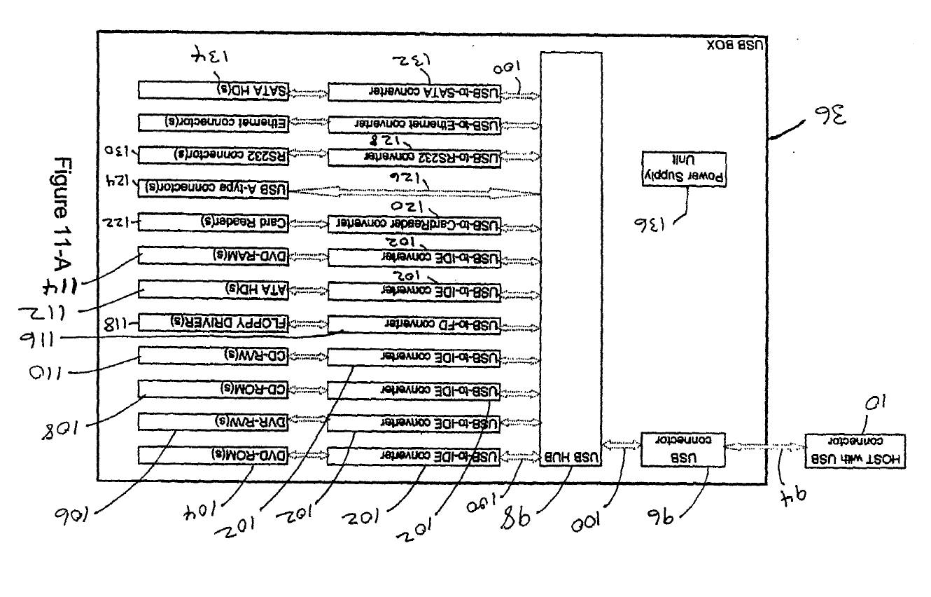

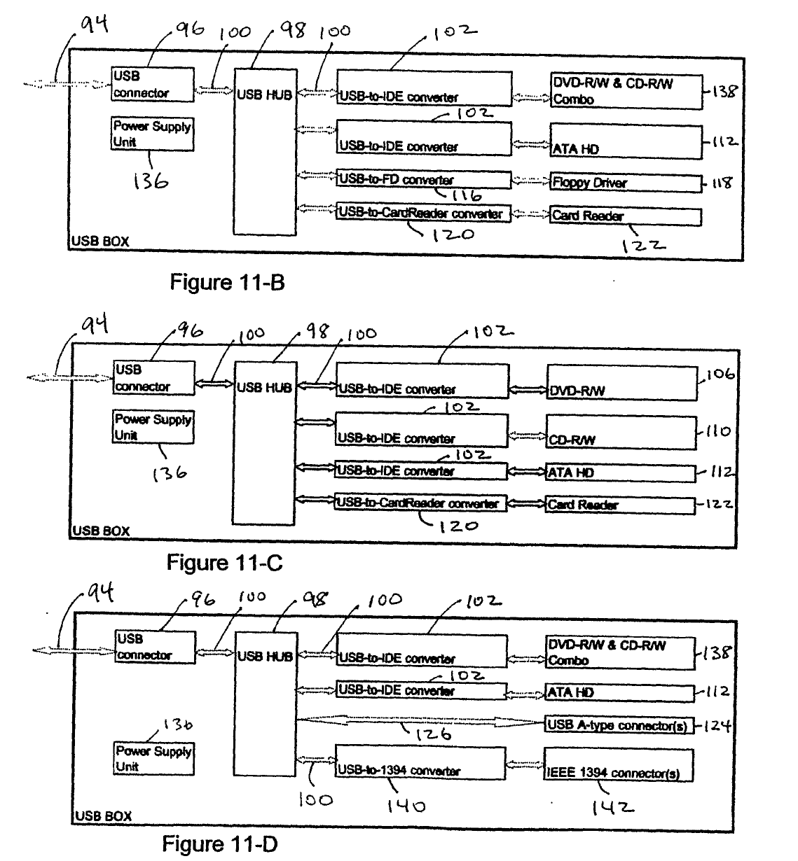

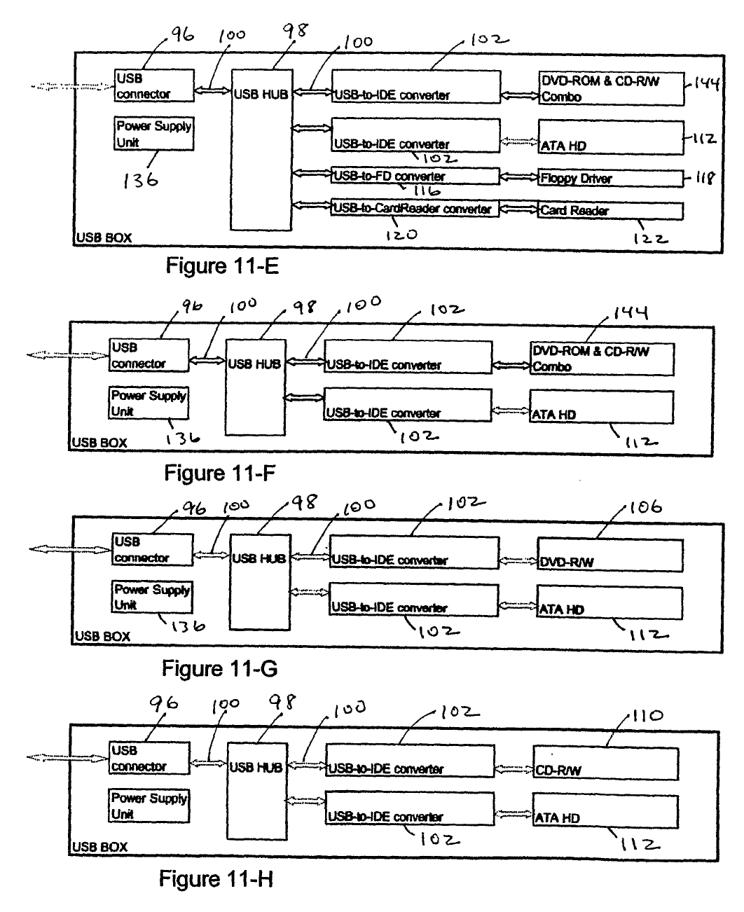

Referring to FIG. 11-A, exemplary internal components of a peripherals unit 36 of an embodiment of the invention is depicted by means of a block diagram. Unit 36 may be connected with unit 10 by means of USB connection 96. One end of USB connection 94 is connected to USB port 26 of unit 10 and the other end of USB connection 94 is connected to USB connection 96 of unit 36.

USB connection 96 is connected to a USB hub 98 by means of cable 100. USB hub 98 contains a series of USB ports for connecting various devices to USB hub 98. These devices are depicted in FIG. 7-1 as examples.

USB-to-IDE converter 102 is connected to USB hub by means of USB connection 100. A DVD-ROM drive or drives 104 is connected to USB-to-IDE converter 102. This enables unit 10 to control DVD-ROM drive 104 when unit 10 is connected to unit 36 by means of USB connection 94.

Additionally, or alternatively, a second USB-to-IDE converter 102 may be connected to USB hub 98 by means of USB connection 100. DVR-R/W drive or drives 106 may then be connected to USB-to-IDE converter 102 in order to enable unit 10 to control DVR-R/W drive 106 when connected to unit 36.

Similarly, one or more USB-to-IDE converters 102 may be connected to USB hub 98 with USB connection 100 in order to connect CD-ROM drive 108, CD-R/W drive 110, ATA HD drive and/or DVD-RAM drive 114.

In addition, USB-to-FD converter 116 may be connected to USB hub 98 by means of USB connection 100 in order to connect with floppy drive 118 to enable unit 10 to read and write to floppy drive 118 of unit 36 when unit 10 is connected to unit 36 by means of USB connection 94.

Similarly, USB-to-Card Reader Converter 120 is connected to USB hub 98 to enable card reader 122 to be connected to unit 10 though USB connection 100, USB hub 98, USB connection 94 to enable the reading and writing of data to memory cards in card reader 122 by unit 10.

In order to enable connection of additional USB devices, a series of USB A-type connectors 124 connect directly to USB hub 98 by means of USB connection 126.

A USB-to-RS232 converter 128 is connected to USB hub 98 at one end and to RS232 connector 130 at the other end, to enable RS232 connector 130 to be connected to USB hub 98.

USB-to-SATA converter 132 is connected to USB hub 98 at one end by means of USB connection 100 and to SATA HDD 134 at the other end, in order to connect SATA HDD 134 to USB hub 98.

Power supply unit 136 supplies power to the various peripherals within housing 44 of unit 36. This includes fan system 64 (FIG. 7) as well as an electrical cord and plug to plug into a electrical wall receptacle to provide power to unit 36.

It should be noted that unit 36 does not contain any processor, motherboard (i.e. chip set), and RAM memory. Rather processor 70, chipset 72, O/O chip 78 and RAM memory 86 are contained within the motherboard of unit 10.

FIGS. 11-B to 11-I show alternate embodiments of FIG. 11-A with alternative peripherals housed within housing 44 of unit 36.

FIG. 11-B depicts an alternate embodiment of FIG. 11-A in which the peripherals are identified as a DVD RAN and CD-R/W combination drive 138, an ATA HD 112, floppy driver 118 and card reader 122. A pair of USB-to-IDE converters connect drive 138 and ATA HD 112 respectively to USB hub 98 by means of USB connection 100. Unit 10 may be connected to unit 36 using USB connection 94. USB-to-Card Reader Converter 120 is connected to USB hub 98 to enable card reader 122 to be connected to unit 10 through USB connection 100, USB hub 98, USB connector 96 and USB connection 94 to enable the reading and writing of data to memory cards in card reader 122 by unit 10. USB-to-FD converter 116 is connected to USB hub 98 by means of USB connection 100 in order to connect with floppy drive 118 to enable unit 10 to read and write to floppy disk drive 118 of unit 36 when unit 10 is connected to unit 36 by means of USB connection 94.

FIG. 11-C depicts an alternate embodiment of FIG. 11-A in which the peripherals are DVD R/W drive 106, CD-R/W drive 110, ATA HD 112, and card reader 122. Three USB-to-IDE converters connect drives 106 and 110 as well as ATA HD 112 respectively to USB hub 98 by means of USB connection 100. Unit 10 may be connected to unit 36 using USB connection 94. USB-to-Card Reader Converter 120 is connected to USB hub 98 to enable card reader 122 to be connected to unit 10 through USB connection 100, USB hub 98, and USB connector 96 to enable the reading and writing of data to memory cards in card reader 122 by unit 10.

FIG. 11-D depicts an alternate embodiment of FIG. 11-A in which the peripherals are DVD R/W and CD-R/W combination drive 138, ATA HD 112, a series of USB A-type connectors 124 and IEEE1394 connectors 142. A pair of USB-to-IDE converters connect drive 138 and ATA HD 112 respectively to USB hub 98 by means of USB connection 100. USB-to-1394 converter connects IEEE 1394 connector 142 or a series of those connectors to USB hub 98 by means of USB connection 100.

FIG. 11-E is identical to FIG. 11-B except that DVD-ROM &CD-R/W combination drive 144 replaces DVD-R/W & CD-R/W combination drive 138.

FIG. 11-F depicts an alternate embodiment of FIG. 11-A in which the peripherals are DVD-ROM and CD-R/W combination drive 144 and ATA HDD 112.

FIG. 11-G depicts an alternate embodiment of FIG. 11-A in which the peripherals are DVD R/W drive 106 and ATA HDD 112.

FIG. 11-H depicts an alternate embodiment of FIG. 11-A in which the peripherals are CD-R/W drive 110 and ATA HDD 112.

Peripherals unit 36 could also include more USB ports or Firewire (1394) ports, a Network port and so on, depending on the user's requirements.

An alternate embodiment of the invention will be described with reference to FIGS. 12 and 13. It should be understood that the internal components described with FIGS. 12 and 13 can also be similarly incorporated into the embodiment described in FIGS. 1 through 5. The main distinction between the embodiment depicted in FIGS. 1 through 5 and as compared to the embodiment of FIGS. 12 and 13 is the fact that the outer dimensions of the embodiment of FIGS. 12 and 13 is such that unit 10 may fit within the typical 5.25 inch computer bay of a typical computer system. However it should be understood that unit 10 may also be configured to fit within the typical 3.5 inch computer bay. This should be compared with the embodiment of unit 10 in FIGS. 1 through 5 which is designed to be linked externally with a typical computer or a peripherals unit 36, rather than internally in a 5.25 inch drive bay (or 3.5 inch drive bay) of a typical computer system or peripherals unit 36.

Referring to FIG. 12, in order to fit within the standard 5.25 inch bay of a typical computer, the height 146 of unit 10 should be less than 41.4 millimetres. The width 148 of unit 10 should be less than 146.5 millimetres and the depth 150 of unit 10 should be less than about 162 millimetres. Unit 10 includes housing 152 comprising rectangular box portion 154 with front face 156 covering the front end of box portion 154. The rear of box portion 154 is open to form opening 158.

The inner components of unit 10 will be discussed with reference to both FIGS. 12 and 13. A motherboard 160 fits within box portion 154 adjacent the bottom 162 of box portion 154. Random access memory 164 is connected to motherboard 160 to provide random access memory to unit 10. A central processing unit 166 is also connected to motherboard 160 and provides processing power to unit 10. Audio jack 168 is connected to the front end of motherboard 160 aligned with opening 170 of front face 156. A series of USB ports and/or IEEE 1394 ports 172 are connected to front end of motherboard 160 aligned with opening 174. A LAN connection 176 is also connected to motherboard 160 adjacent the front end of motherboard 160 and aligned with opening 178. An optional S-video input jack 180 is positioned on motherboard 160 aligned with opening 182. Audio jack 168 and LAN connection 176 are optional components and may be omitted if desired.

The internal components of unit 10 further include a DVI jack 184 aligned with opening 186 of face 156. Power jack 188 is further attached to motherboard 160 at a front end of motherboard 160 adjacent DVI jack 184 and aligned with opening 190. Internal Speaker 192 is positioned above power jack 188 and is connected to motherboard 160 in a suitable manner. Speaker 192 is an optional component and may be omitted if desired. Power button 194 is attached to box portion 154 by means of brackets 196. Power button 194 is aligned with opening 198. The rear of motherboard 160 includes an IDE connector and cable 200 connected to motherboard 160. USB connector and cable 202 are attached to the rear of motherboard 160 adjacent connector and cable 200. A SATA connector and cable is connected to motherboard 160 adjacent USB connector and cable 202 for internal connection with the peripherals. Connectors 200, 202 and 204 are used to connect peripheral devices, or peripherals unit 36 as described above to unit 10 when in the 5.25 inch bay of peripherals unit 36, or of a typical computer system. If connected to a typical computer system, unit 10 can be used to replace the motherboard, CPU and other related components of the typical computer, with corresponding components of unit 10. In this way, an upgraded CPU contained within unit 10 can easily be matched with, and configured to operate, a hard drive and other peripheral components of a typical computer, without having to replace the computer. Only the components corresponding to those of unit 10 are no longer used as they are replaced by inserting unit 10 into the 5.25 inch bay of the typical computer and operatively connecting unit 10 to the peripherals in that computer.

FIG. 14 depicts a the vertical peripherals unit 36 of FIG. 6-1 with unit 145 substituted for optical drive 49. Unit 145 is an alternate embodiment of unit 10, identical to unit 10 of FIGS. 12 and 13, although mounted within the bay otherwise occupied by optical drive 49 (FIG. 6-1) and contains a housing, a motherboard carried by the housing, a central processing unit operatively connected to the motherboard, volatile memory operatively connected to the motherboard, and one or more connectors operatively connected to the motherboard each accessible from outside the housing. The connectors are configured to selectively connect, as desired, with a computer-operated peripheral device 36 to operatively connect device 36 to the motherboard for operative connection to the central processing unit to operate with the device 36. No other computer-operated components, other than the motherboard, central processing unit, volatile memory, and one or more connectors, and no computer-operated peripheral devices, are carried by the housing.

As will be apparent to those skilled in the art to which the invention is addressed, the present invention may be embodied in forms other than those specifically disclosed above, without departing from the spirit or essential characteristics of the invention. The particular embodiments of the invention described above and the particular details of the processes described are therefore to be considered in all respects as illustrative or exemplary only and not restrictive. Other configurations could be developed based on known computer and processor configurations, or as may in the future be developed. The scope of the present invention is as set forth in the complete disclosure rather than being limited to the examples set forth in the foregoing description. Any and all equivalents are intended to be embraced.

1. A discrete, self-contained computer processing system for selectively connecting to one or more computer-operated peripheral devices to form an operating computer system to operate the peripheral device or devices, the computer processing system comprising:
(a) a housing;
(b) a motherboard within the housing;
(c) a central processing unit operatively connected to the motherboard;
(d) a volatile memory operatively connected to the motherboard; and
(e) one or more connectors operatively connected to the motherboard each accessible from outside said housing, said connectors configured to selectively connect, as desired, with the one or more computer-operated peripheral devices to operatively connect the one or more devices to the motherboard for operative connection to the central processing unit to operate with the device; and
wherein no other computer-operated components, other than the motherboard, central processing unit, volatile memory, and one or more connectors, and no computer-operated peripheral devices, are included in the housing.

2. The system as described in claim 1 further comprising a small form factor nonvolatile memory socket for connecting a small form factor non-volatile memory storage device.

3. The system as described in claim 2 wherein the socket is a compact flash socket.

4. The system as described in claim 1 further comprising a small form factor non-volatile memory storage device operatively connected to the motherboard.

5. The system as described in claim 4 wherein the small form factor non-volatile memory storage device contains the minimum operating software necessary for the operation of the system.

6. The system as described in claim 1 wherein the housing and motherboard, central processing unit, volatile memory are small form factor in size.

7. (canceled)

8. (canceled)

9. (canceled)

10. The system as described in claim 1 wherein the connector comprises a USB port, a power jack or a video port.

11. The system as described in claim 1 wherein the system comprises a plurality of connectors and where the connectors are one or more USB ports and/or video ports.

12. The system as described in claim 1 further comprising a communications port for accepting a communication device for connecting the central processing unit to the communication device.

13. A discrete, self-contained computer processing system for selectively connecting to one or more computer-operated peripheral devices to form an operating computer system to operate the peripheral device or devices, the computer processing system comprising:
(a) a housing;
(b) a motherboard within the housing;
(c) a central processing unit operatively connected to the motherboard:
(d) a communications device operatively connected to the motherboard,
(e) a volatile memory operatively connected to the motherboard; and
(f) one or more connectors operatively connected to the motherboard each accessible from outside said housing, said connectors configured to selectively connect, as desired, with the one or more computer-operated peripheral devices to operatively connect the one or more devices to the motherboard for operative connection to the central processing unit to operate with the device; and
wherein no other computer-operated components, other than the motherboard, central processing unit, communications device, volatile memory, small form factor hard drive and one or more connectors, and no computer-operated peripheral devices, are included in the housing.

14. The system as described in claim 1 wherein the housing dimensions are less than or equal to the dimensions of a 3.5 inch floppy drive to permit the computer processing system to be placed within a drive bay of a computer, the bay configured to accept a 3.5 inch floppy disk drive.

15. The system as described in claim 1 wherein the housing dimensions are less than or equal to the dimensions of a 5.25 inch optical drive device to permit the computer processing system to be placed within a bay of a computer, the bay configured to accept a 5.25 inch optical drive device.

16. A discrete peripherals unit for selectively connecting to the computer processing system of claim 1 to form an operating computer system to operate the peripherals unit, the computer processing system comprising:
(a) a housing;
(b) one or more computer-operated peripheral devices included in the housing;
(c) a hub connecting the one or more computer-operated peripheral devices to a connector accessible from outside said housing, said connector configured to selectively operatively connect, as desired, the one or more computer-operated peripheral devices to the computer processing system of claim 1 to permit the central processing unit of the computer processing system of claim 1 to operate with the one or more peripheral devices when so connected; and
wherein the peripherals unit system does not include a motherboard, a central processing unit and volatile memory for operating the peripherals devices.

17. A computer system comprising, in combination:
(a) the discrete self-contained computer processing system of claim 1; and
(b) the discrete peripheral unit of claim 16 operatively connected to the computer processing system of claim 1.

18. A method of upgrading the central processing unit of a computer system containing one or more computer-operated peripheral devices, comprising the steps of:
(a) disconnecting the existing central processing unit from the one or more computer-operated peripheral devices of the computer system:
(b) operatively connecting the self-contained computer processing system of claim 1 to the one or more peripheral devices or a computer system containing one or more computer-operated peripheral devices; and
(c) operating the one or more peripheral devices with the self-contained computer processing system of claim 1.

19. The method of claim 18 further comprising, at step (b), the step of inserting the self-contained computer processing system of claim 1 dimensioned to fit within a drive bay of the computer system, into the drive bay.
